(19) United States
(12) Patent Application Publication
(10) Pub. No.: US 2005/0132730 A1
(43) Pub. Date: Jun. 23, 2005

(54) Apparatus and method for controlling operation of blower fan of refrigerator

(75) Inventors: Hyoung Keun Lim, Suwon-si (KR); Yang Gyu Kim, Seoul (KR); Se Young Kim, Seoul (KR); Chan Ho Chun, Seoul (KR); Youn Seok Lee, Goyang-si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 10/988,509

(22) Filed: Nov. 16, 2004

(30) Foreign Application Priority Data
Dec. 18, 2003 (KR) 93124/2003

(51) Int. Cl. G05D 23/32; F25D 17/04

(52) U.S. Cl. 62/157; 62/186

(57) ABSTRACT

Apparatus and method for controlling an operation of a blower fan are provided. In the apparatus and method, a temperature of an evaporator is measured, and an amount of cool air remaining in the evaporator is computed from the measured temperature of the evaporator such that the cool air of the evaporator can be sufficiently used. According to the present invention, a use efficiency of the refrigerator can be further enhanced.

### BACKGROUND OF THE INVENTION

1. Field of the Invention

The present invention relates to a method for controlling a refrigerator, and more particularly, to an apparatus and method for controlling an operation of a blower fan of a refrigerator that can optimize an end timing of an extending operation of the blower fan such that cool air remaining in an evaporator can be used after an operation of a compressor is ended.

2. Description of the Related Art

A cooling cycle apparatus such as a refrigerator includes a compressor for compressing a low temperature and low pressure gas refrigerant, a condenser for condensing a high pressure refrigerant compressed in the compressor by radiating heat of the high pressure refrigerant, an throttle valve for reducing a pressure of the refrigerant condensed in the condenser, and an evaporator in which the refrigerant adiabatically expanded in the throttle valve deprives a freezer room and a cold storage room of heat and is vaporized. The evaporator includes a blower fan for forcibly sending air. The present invention is focused on apparatus and method for controlling the blower fan.

In a general refrigerator, the compressor is controlled by a control method on the basis of a temperature of a freezer.

The conventional control method on the basis of the temperature of the freezer will now be described in detail. On the basis of the temperature of the freezer, when an inner temperature of a refrigerator rises above an upper limit, the inner space of the refrigerator is cooled by operating the compressor to circulate a refrigerant. After the compressor is driven on the basis of the temperature of the freezer, a damper formed on a connection pipe between the freezer and the cold storage room is opened such that the freezer and the cold storage room are cooled at the same time. When the temperature of the cold storage room is lowered below a lower limit of a preset temperature of the cold storage room, the opened damper is closed such that only the freezer is cooled. Thereafter, when the temperature of the freezer is lowered below the lower limit of the preset temperature of the cold storage room, a cooling cycle starts by a series of repetitive procedure for stopping the operating compressor. In other words, in the refrigerator employing the conventional temperature control method, when the inner temperature of the freezer reaches the upper limit of the preset temperature range of the freezer, the compressor operates, whereas when the inner temperature of the freezer reaches the lower limit of the preset temperature range of the freezer, the compressor stops. The above cycle is repeated.

However, when the compressor stops, low temperature refrigerant that circulates inside of the evaporator is stopped, so that the low temperature refrigerant is left in the evaporator. At this time, since an available cool air of the refrigerant in the evaporator is not used, an energy loss occurs.

Considering the above drawback, the blower fan, which sends air to an inside of the refrigerator via the evaporator, may perform an extending operation in combination with the operation of the compressor by a preset time although the operation of the compressor stops. The time interval of the extending operation of the blower fan is set by an experiment without considering heat load or external condition of the refrigerator.

However, if a proper control of the operation of the blower fan is not performed, the following problems may occur.

First, when the refrigerant remaining in the evaporator is in a low temperature state capable of sufficiently cooling the inside of the refrigerator but the operation of the blower fan is stopped, available cool air is lost and thus energy is wasted.

Second, when the inside of the refrigerator is in a high temperature state that the inside of the refrigerator cannot be further cold due to a very high temperature of the refrigerant remaining in the evaporator but the blower fan continues to operate, the temperature of the refrigerator rises due to heat generated by the operation of the blower fan. At this time, of course, power consumption is increased due to the unnecessary operation of the blower fan.

Owing to the above problems, it is a main issue to properly propose an end timing of an operation of the blower fan.

### SUMMARY OF THE INVENTION

Accordingly, the present invention is directed to an apparatus and method for controlling an operation of a blower fan of a refrigerator that substantially obviates one or more problems due to limitations and disadvantages of the related art.

An object of the present invention is to provide an apparatus and method for controlling an operation of a blower fan of a refrigerator in which a temperature of an evaporator is positively detected, thereby positively controlling an operation of the blower fan depending on a temperature of a refrigerant of an inside of the evaporator.

Another object of the present invention is to provide an apparatus and method for controlling an operation of a blower fan of a refrigerator that can enhance an operation efficiency of the refrigerator using an optimized control algorithm of the blower fan.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a apparatus for controlling operation of a blower fan of a refrigerator, comprising: a series of cycles including a compressor, a condenser, an throttle valve, and an evaporator, in which refrigerant flows to transfer heat of the refrigerator; a temperature sensor for measuring a temperature of the evaporator; the blower fan for blowing air into an inner space of the refrigerator, the blower fan having an operation stop time determined by an amount of a remnant cool air of the evaporator calculated by temperature of the evaporator; and a controller for controlling operation of the blower fan by comparing the amount of remnant cool air with a driving energy of the blower fan.

In another aspect of the present invention, there is provided a method for controlling an operation of a blower fan of a refrigerator, the method comprising: stopping an operation of a compressor; measuring a remnant refrigerant energy of an evaporator using a temperature of the evaporator as one factor; comparing the remnant refrigerant energy of the evaporator with a fan driving energy; and when the remnant refrigerant energy of the evaporator is greater than a preset fan driving energy, extending the operation of the blower fan until the remnant refrigerant energy of the evaporator becomes less than the fan driving energy.

In a further another aspect of the present invention, there is provided a method for controlling an operation of a blower fan of a refrigerator, the method comprising: measuring a remnant refrigerant energy of an evaporator when an operation of a compressor stops; comparing a remnant refrigerant energy of the evaporator with an overall thermal energy having influence on an inner temperature of the refrigerator by an operation of the refrigerator; and when the remnant refrigerant energy of the evaporator is greater than the overall thermal energy, extending the operation of the blower fan until the overall thermal energy becomes less than remnant refrigerant energy of the evaporator.

According to the present invention, an operation efficiency of the refrigerator can be enhanced and a power consumption can be reduced.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a partial cutaway perspective view of a refrigerator according to the present invention;

FIG. 2 is a schematic view of an evaporator according to the present invention;

FIG. 3 is a flow diagram illustrating a method of controlling a blower fan according to the present invention; and

FIG. 4 is a graph comparing and illustrating a relationship between (a) temperature, (b) operation state of a compressor, (c) operation state of a blower fan, and (d) temperature state of an evaporator.

### DETAILED DESCRIPTION OF THE INVENTION

Reference will now be made in detail to the preferred embodiments of the present invention, examples of which are illustrated in the accompanying drawings.

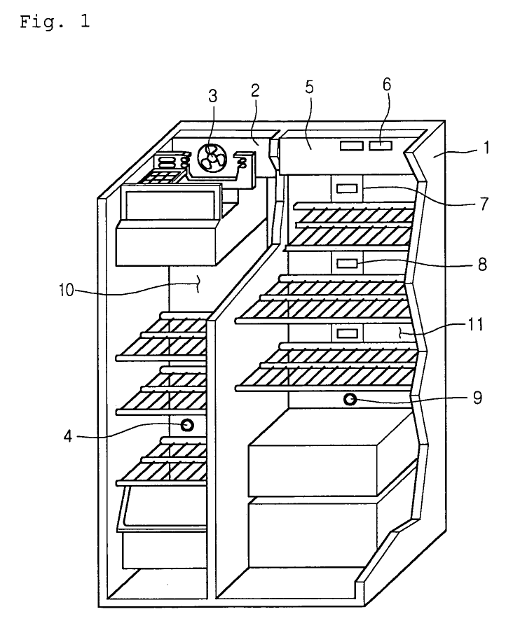

FIG. 1 is a partial cutaway perspective view of a refrigerator according to the present invention.

Referring to FIG. 1, the refrigerator includes a freezer 10, a cold storage room 11, a main body 1 having a barrier partitioning an inner space of the refrigerator into the freezer 10 and the cold storage room 11, a freezer door (not shown) rotatably hinged to the freezer 10 so as to open/close the freezer 10, and a cold storage room door (not shown) rotatably hinged to the main body 1 so as to open/close the cold storage room 11.

The refrigerator also includes a freezer temperature sensor 4 for sensing temperature of the freezer 10 and a cold storage room temperature sensor 9 for sensing temperature of the cold storage room 11.

The refrigerator further includes a blower fan 3 formed at a portion of the freezer 10, for blowing cool air into the inner space of the refrigerator and a blowing room 10, a cool air duct 5 communicated with the blowing room 2, for guiding the cool air to an inner space of the cold storage room, and cool air discharge outlets 6, 7 and 8 designed for discharging the cool air into the inner space of the cold storage room through the cool air duct 5. Of course, a damper (not shown) for opening/closing/partially opening the blowing room 2 and the cool air duct 5 selectively is further formed at a connection portion of the blowing room 2 and the cool air duct 5.

Also, although not shown in the drawing, a compressor, a condenser, an evaporator and an throttle valve forming a cooling cycle are also formed at a predetermined portion of the main body 1. A controller for controlling the operation of the refrigerator is also formed at a portion of the refrigerator.

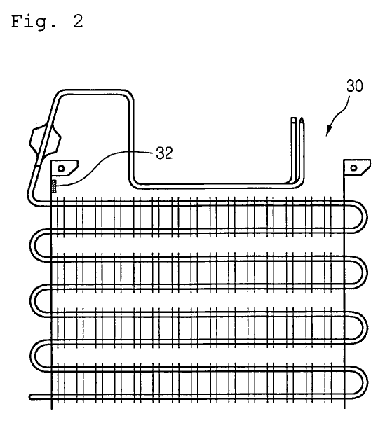

FIG. 2 is a schematic view of an evaporator according to the present invention.

Referring to FIG. 2, the evaporator 30 is installed at a portion adjacent to the blower fan, for vaporizing refrigerant and irradiating heat. The evaporator further includes a defrost sensor 32 disposed at a portion of the evaporator 30, for measuring the temperature of the evaporator 30 such that an effective defrost operation for eliminating frost formed on the evaporator 30 is performed.

Also, it can be deduced that the inventive refrigerator includes a controller for receiving temperature information of the defrost sensor 32 and controlling a whole operation of the refrigerator including the compressor and the blower fan.

Apparatus and method for controlling the blower fan of the refrigerator according to the present invention will now be described with reference to FIGS. 1 and 2.

As the refrigerator starts to operate, a cooling cycle is performed, so that a refrigerant is vaporized. Cool air generated in the evaporator 30 is introduced into the freezer 10 and the cold storage room 11 by the blower fan. When the cold storage room temperature sensor 9 detects that the inner temperature of the cold storage room is lowered below a predetermined temperature, the damper (not shown) disposed between the blowing room 2 and the cool air duct 5 is blocked such that the cool air is introduced only into the freezer. Also, when the freezer temperature sensor 4 detects that the inner temperature of the freezer is lowered below a predetermined temperature, the operation of the compressor stops, so that new cool air is not introduced into the evaporator. However, the blower fan 3 does not stop in combination with the compressor but operates separately from the compressor.

From this time, a procedure for determining the operation of the blower fan by a positive determination is performed. In detail, when the defrost sensor 32 senses the temperature of the evaporator 30, the cool air of the refrigerant remaining in the evaporator 30 is compared with a driving energy of the blower fan. As a result of the comparison, when the cool air of the evaporator is greater than the driving energy of the blower fan, the blower fan continues to operate such that the cool air is introduced, whereas when the cool air of the evaporator is smaller than the driving energy of the blower fan, the operation of the blower fan stops.

Next, the apparatus and method for controlling the operation of the blower fan according to the present invention will now be described in detail.

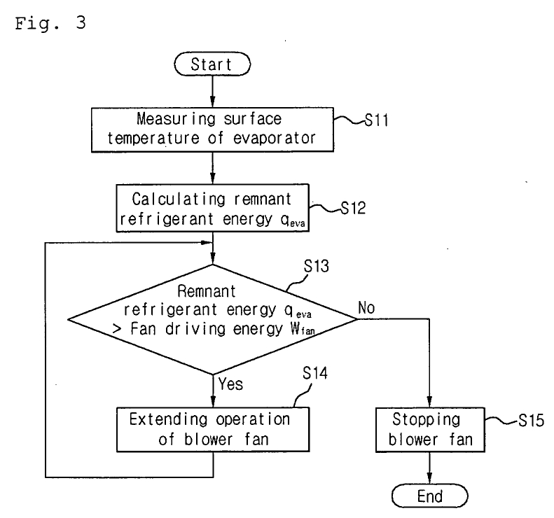

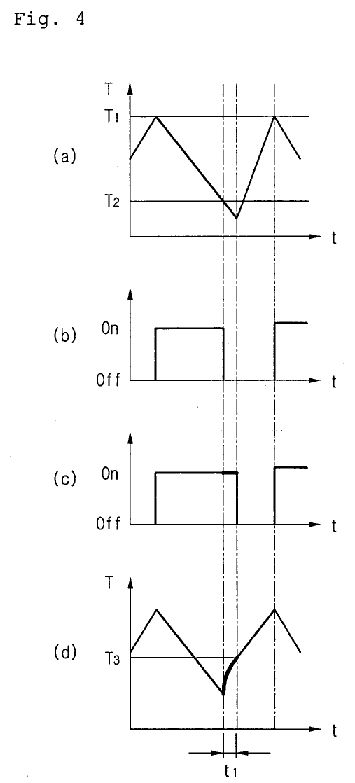

FIG. 3 is a flow diagram illustrating a method of controlling a blower fan according to the present invention, and FIG. 4 is a graph comparing and illustrating a relationship between (a) temperature, (b) operation state of a compressor, (c) operation state of a blower fan, and (d) temperature state of an evaporator.

Referring to FIGS. 3 and 4, when the temperature of the refrigerator reaches an upper limit Ti of a set temperature, the compressor and the blower fan 3 operate, so that the temperature of the refrigerator is lowered and the temperature of the defrost sensor 32 is also lowered. Meanwhile, when the temperature of the refrigerator reaches a lower limit T2 of the set temperature, the operation of the compressor stops but the blower fan 3 continues to operate.

From this time, a predetermined algorithm capable of determining On/Off operation of the blower fan 3 is performed.

In detail, the defrost sensor 32 installed in the evaporator 30 measures the surface temperature of the evaporator 30 (S11). From the measured surface temperature of the evaporator 30, a remnant refrigerant energy of the evaporator 30 is measured (S12). The remnant refrigerant energy qₑᵥₐ can be obtained by a below equation 1:
qₑᵥₐ=(Cₚ)ₐᵢᵣ·ε·(T_{air,in}−Tₑᵥₐ) Equation 1
where, T_{air,in}=T_{ref}+α,
qₑᵥₐ is temperature of the evaporator,
α is a difference between a temperature measured by temperature sensor and actual inner temperature of the refrigerator,
ε is an efficiency of the evaporator,

$$where ɛ = 1 - {ⅇ}^{- NTU} , \\ where NTU = \frac{UA}{{( {mC}_{p} )}_{air}}$$

where UA is an overall heat transfer coefficient and (mCₚ)ₐᵢᵣ is flow of thermal capacitance of air

Next, the obtained remnant refrigerant energy qₑᵥₐ is compared with a fan driving energy W_{fan}, thereby determining which one is greater than the other (S13).

An end timing of an extending operation of the blower fan 3 can be obtained by a below equation 2:
qₑᵥₐ<k·W_{fan} Equation 2,
k=1, which corresponds to a case that COP of the refrigerator is below 1
k=COP, which corresponds to a case that COP of the refrigerator is above 1,
where qₑᵥₐ is the remnant refrigerant energy of the evaporator and W_{fan} is the fan driving energy.

The fan driving energy is preset according to kinds of the blower fan.

In the determining operation S13, when the remnant refrigerant energy qₑᵥₐ of the evaporator is greater than the fan driving energy W_{fan}, the operation of the blower fan 3 is extended until the remnant refrigerant energy qₑᵥₐ of the evaporator is less than the fan driving energy W_{fan} (S14). Also, when the remnant refrigerant energy qₑᵥₐ of the evaporator is smaller than the fan driving energy W_{fan}, the operation of the blower fan 3 performing the extending operation is stopped (S15).

Referring to FIG. 4, it is shown that the blower fan 3 performs the extending operation during a predetermined time T1 until the defrost sensor 32 reaches a selected temperature T3. The extending operation time is marked by a bold solid line on the graph of FIG. 4(c).

As proposed in the present invention, the operation of the blower fan is determined in an advantageous direction by when the operation of the compressor is stopped, comparing the amount of the cool air of the refrigerant remaining in the evaporator with the driving energy as a thermal energy to be generated in the operation of the blower fan. As a result, the cool air remaining in the evaporator can be used to a sufficient degree, and an elevation of temperature due to an excessive operation of the blower fan can be prevented in advance.

It is noted that the inventive method for controlling the blower fan can be applied to a top mount-type refrigerator where the freezer (F) and the cold storage room (R) are separated into an upper portion and a lower portion, and a bottom freezer-type refrigerator where the cold storage room (R) and the freezer (F) are separated into an upper portion and a lower portion, as well as the side by side-type refrigerator, according to an embodiment of the present invention, where the freezer (F) and the cold storage room (R) are separated into a left portion and a right portion.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for controlling operation of a blower fan of a refrigerator, comprising:
a series of cycles including a compressor, a condenser, an throttle valve, and an evaporator, in which refrigerant flows to transfer heat of the refrigerator;
a temperature sensor for measuring a temperature of the evaporator;
a blower fan for blowing air into an inner space of the refrigerator, the blower fan having an operation stop time determined by an amount of a remnant refrigerant in the evaporator calculated by temperature of the evaporator; and
a controller for controlling operation of the blower fan by comparing the amount of the remnant refrigerant with a driving energy of the blower fan.

2. The apparatus according to claim 1, wherein the temperature sensor measures a surface temperature of the evaporator.

3. The apparatus according to claim 1, wherein when the amount of the cooling energy by the remnant refrigerant is greater than the driving energy of the blower fan, the controller controls the blower fan to continue the operation.

4. The apparatus according to claim 1, wherein when the amount of the cooling energy by the remnant refrigerant is smaller than the driving energy of the blower fan, the controller transmits a control signal to stop the operation of the blower fan.

5. The apparatus according to claim 1, wherein the temperature sensor is a defrost sensor used in a defrost operation of the evaporator.

6. A method for controlling an operation of a blower fan of a refrigerator, the method comprising:
stopping an operation of a compressor;
measuring a remnant refrigerant energy of an evaporator using a temperature of the evaporator as one factor;
comparing the remnant refrigerant energy of the evaporator with a fan driving energy; and
when the remnant refrigerant energy of the evaporator is greater than a preset fan driving energy, extending the operation of the blower fan until the remnant refrigerant energy of the evaporator becomes less than the preset fan driving energy.

7. The method according to claim 6, wherein the temperature of the evaporator is measured from a surface temperature of the evaporator.

8. The method according to claim 6, wherein the compressor stops when a temperature of a freezer room is below a set temperature.

9. The method according to claim 6, wherein the remnant refrigerant energy of the evaporator qₑᵥₐ is obtained by a below equation:
qₑᵥₐ=(Cₚ)ₐᵢᵣ·ε·(T_{air,in}−Tₑᵥₐ)
where, T_{air,in}=T_{ref}+α,
qₑᵥₐ is temperature of the evaporator,
α is a difference between a temperature measured by temperature sensor and actual inner temperature of the refrigerator,
ε is an efficiency of the evaporator,
$$where ɛ = 1 - {ⅇ}^{- NTU} , \\ where NTU = \frac{UA}{{( {mC}_{p} )}_{air}}$$
where UA is an overall heat transfer coefficient and (mCₚ)ₐᵢᵣ is flow of thermal capacitance of air.

10. The method according to claim 6, wherein the preset fan driving energy is obtained by a below equation:
k·W_{fan}
where W_{fan} is a fan driving energy corresponding to fan type, and
k=1, which corresponds to a case that COP of the refrigerator is below 1
k=COP, which corresponds to a case that COP of the refrigerator is above 1,

11. The method according to claim 6, wherein the remnant refrigerant energy of the evaporator is obtained by multiplying a heat capacitance of air, an efficiency of the evaporator, and a difference between an external temperature and a temperature of the evaporator.

12. The method according to claim 6, wherein the preset fan driving energy is a thermal conversion value of a mechanical energy generated when the blower fan moves.

13. The method according to claim 6, wherein the blower fan sends cool air to a freezer and a cold storage room at the same time.

14. The method according to claim 6, wherein when the operation of the blower fan is ended and a temperature of the refrigerator is above a set temperature, the compressor and/or the blower fan operate again.

15. The method according to claim 6, wherein before the operation of the compressor is ended, a damper for separating a cold storage room from a freezer is first closed.

16. A method for controlling an operation of a blower fan of a refrigerator, the method comprising:
measuring a remnant refrigerant energy of an evaporator when an operation of a compressor stops;
comparing a remnant refrigerant energy of the evaporator with an overall thermal energy having influence on an inner temperature of the refrigerator by an operation of the refrigerator; and
when the remnant refrigerant energy of the evaporator is greater than the overall thermal energy, extending the operation of the blower fan until the overall thermal energy becomes less than remnant refrigerant energy of the evaporator.

17. The method according to claim 16, wherein the overall thermal energy comprises a fan driving energy of the blower fan.

18. The method according to claim 16, wherein when the remnant refrigerant energy of the evaporator is smaller than the overall thermal energy, stopping the operation of the blower fan.

19. The method according to claim 16, wherein the remnant refrigerant energy of the evaporator increases as the temperature of the evaporator is lowered.

20. The method according to claim 16, wherein the remnant refrigerant energy of the evaporator increases as the amount of the refrigerant of the evaporator increases.

21. The method according to claim 16, wherein the remnant refrigerant energy of the evaporator increases as an outer temperature is elevated.
